(19) United States
(12) Patent Application Publication
(10) Pub. No.: US 2010/0180236 A1
(43) Pub. Date: Jul. 15, 2010

(54) Setting and previewing method of dynamically orienting 3D models and machines readable medium thereof

(76) Inventors: Alan C. Lin, Taipei City (TW); Chi-Tien Shih, Sijhih City (TW); Chun-Yu Liu, Yuanlin Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/318,828

(22) Filed: Jan. 9, 2009

(51) Int. Cl. G06T 15/00; G06F 3/048

(52) U.S. Cl. 715/851; 345/419

(57) ABSTRACT

A setting and previewing method of dynamically orienting 3D models is provided for reading components of an object model and size features of each component from a model database and displaying them on an interface. The method includes the steps of: selecting one of the size features of the component from a storage unit, and reading a viewing parameter from the component that controls the viewing angle of the component; drawing the selected component displaying the size feature according to the viewing parameter; adjusting the viewing angle of the component so that the size feature of the component can be viewed from different viewing angles on the interface; reading a new viewing parameter of the component resulting from the adjusting step, and then saving the new viewing parameter to the storage unit.

### BACKGROUND OF THE INVENTION

1. Field of the Invention

The present invention relates to a method for 3D model dynamic orientation; in particular, to a setting and previewing method for dynamically orienting 3D models.

2. Description of Related Art

At present, various commercially available 3D model drawing tools have been developed on the market. Before producing a product, designers can use the 3D model drawing tools to preview the forms of the final product beforehand, and conveniently modify the design or correct errors through the operation interfaces and options provided by the drawing tools; therefore, designers' dependence on such 3D model drawing tools has increased significantly.

However, due to such increasing demand on said 3D model drawing tools, undesirable inconveniences during use of the tools also gradually occur in user operations. Taking the object model commonly used in industrial design for example, each object model consists of several or tens of or more different components, and users usually need to perform previewing at different viewing angles or modify size values on certain components contained therein; certain 3D model drawing tools provide simply textual descriptions without picture preview, thus users may not fully appreciate the relationship regarding to position and size between the component and the object model merely based on the provided textual information concerning the model or the component.

Meanwhile, although certain 3D model drawing tools indeed provide 2D pictures to show the relationship between each component and the entire model, in case more components exist in the model, more pictures are accordingly required which not only occupy a large amount of storage space but need to be repeatedly read and previewed during the use of tool, causing inconvenience in operations. Besides, since each component is displayed in a 2D fashion in such pictures, users can only preview a specific component at a fixed viewing angle (usually at the angle of right in front of the component), which restricts the operations and previewing by the user, thus also leading to inconvenience.

In order to let the 3D model drawing tools better meet the requirements on operations of users, it is needed to propose an effective method to provide desirable conveniences with regards to display and previewing operations of relationships between each component of a model and the model, such that the users are able to design more sophisticated and precise products, thereby fully exploiting the value of 3D model drawing tools.

### SUMMARY OF THE INVENTION

In order to resolve the aforementioned drawbacks, the present invention provides a method for 3D model dynamic orientation, allowing to achieve the purpose of providing more desirable conveniences in display and operations of 3D models and each component thereof.

To achieve the above-mentioned objective, one solution according to the present invention provides a setting method for dynamically orienting 3D models, applicable for setting a viewing angle of a component in an object model shown on a user interface, comprising the following steps: receiving an operation command, and performing adjustment on viewing angle of a component used to present a size feature displayed on the user interface based on the operation command; upon reception of an update command, reading a viewing parameter generated for the component after the said adjustment on viewing angle; finally, transferring the viewing angle to a storage unit for storage; wherein the viewing parameter is used to control the viewing angle, position and scale when the component presents the size feature on the user interface.

Furthermore, to achieve the aforementioned objective, one solution according to the present invention provides a previewing method for dynamically orienting 3D models, applicable for previewing the viewing angle of at least one component of an objective model, comprising the following steps: selecting an identification data of a size feature of the component based on a selection command; reading and determining whether a viewing parameter of the component displaying the size feature is stored in a storage unit; if the viewing parameter is found to exist in the storage unit, reading the viewing parameter; performing adjustment on the viewing angle of the component based on the viewing parameter; upon completion of the adjustment, drawing the component, size feature and size value based on the viewing angle and displaying them on the user interface; wherein the viewing parameter is used to control the viewing angle, position and scale when the component presents the size feature on the user interface.

The methods provided by the present invention can be recorded on a physical medium by means of program codes, and after loading and executing the program codes by a computer, the computer can be configured as a device used to implement the present invention.

### BRIEF DESCRIPTION OF THE DRAWINGS

FIG. 1 is a block diagram of an embodiment for the 3D model dynamic orientation system according to the present invention;

FIG. 2 is a flowchart of an embodiment for the 3D model dynamic orientation setting method according to the present invention;

FIG. 3 is a flowchart of an embodiment for the 3D model dynamic orientation previewing method according to the present invention;

FIG. 4 is a flowchart of an embodiment for the 3D model dynamic orientation executing method according to the present invention;

FIG. 5 is a diagram of a viewing angle coordinate matrix according to the present invention;

FIG. 6A is a diagram of a user interface displaying the viewing angle of a component and information on the component and size feature according to the present invention;

FIG. 6B is a diagram of a user interface displaying the component and size feature after adjustment on viewing angle according to the present invention; and

FIGS. 7A and 7B are diagrams of a user interface displaying the component and size feature according to the present invention.

### DETAILED DESCRIPTION OF PREFERRED EMBODIMENTS

The present invention provides a setting and previewing method for dynamically orienting 3D models which is applicable for dynamically adjusting the viewing angle of at least one component in an object model, and recording the adjusted results, so as to, repeatedly based on the setting results, achieve the effect of previewing the object model and each component feature at various viewing angle, thereby improving the conveniences in 3D model previewing and operations. To facilitate more thorough illustration and explanation, descriptions are made hereinafter with reference to several appended block diagrams and drawings in order to more precisely and clearly disclose the technologies and means employed in the present invention.

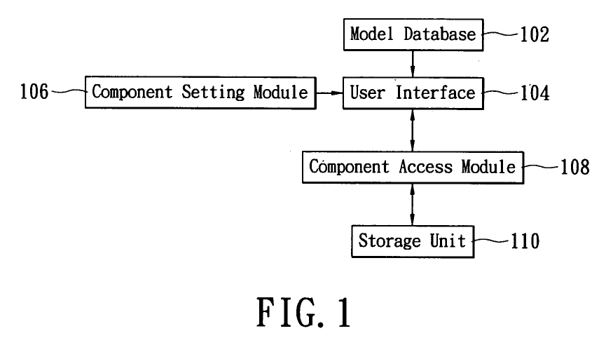

FIG. 1 shows a block diagram of an embodiment for the 3D model dynamic orientation system according to the present invention, comprising a model database 102, a user interface 104, a component setting module 106, a component access module 108 and a storage unit 110. The model database 102 records at least one object model, each component of the object model, the identification data for each size feature of each component and the size value of the size feature; the user interface 104 is used to display the object model, component and size feature of the component read from the model database 102 for previewing; the component setting module 106 is used to perform rotation operation on the component displayed on the user interface 104, allowing the size feature of the component to be rendered on the user interface 104 at different viewing angles; the component access module 108 is used to transfer a viewing parameter generated after rotating the component presenting the specific size feature to the storage unit 110 for storage, or acquiring the viewing angle from the storage unit 110 so as to display a specific size feature of the component on the user interface 104.

The object models described in the present embodiment and following texts include 3D models of objects like a gear, a bolt and a gasket etc. Taking the gear for example, it comprises the components such as a hub, an inner diameter, a key, gear teeth and so forth; the size feature of each component can be, for example, width of hub, length of inner diameter, key height or key length and other relevant items.

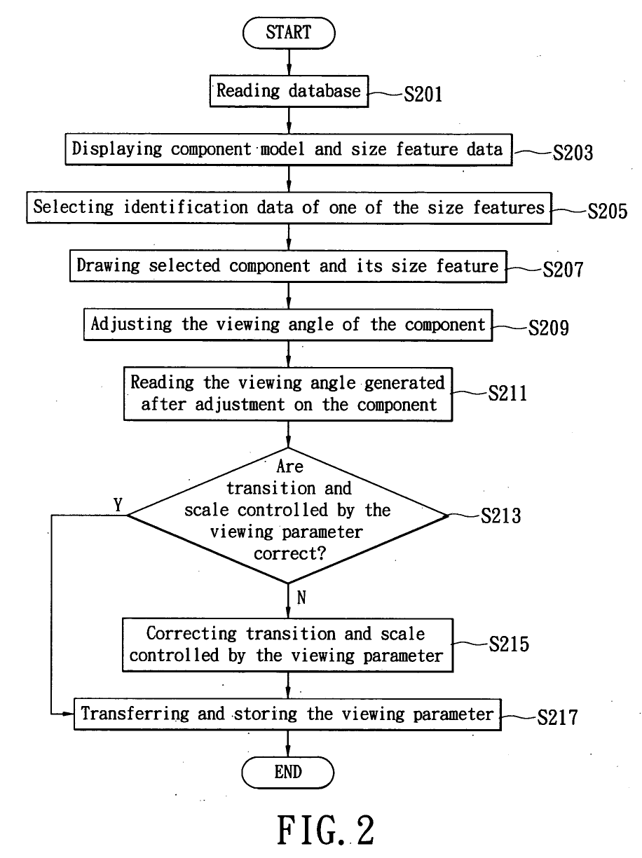

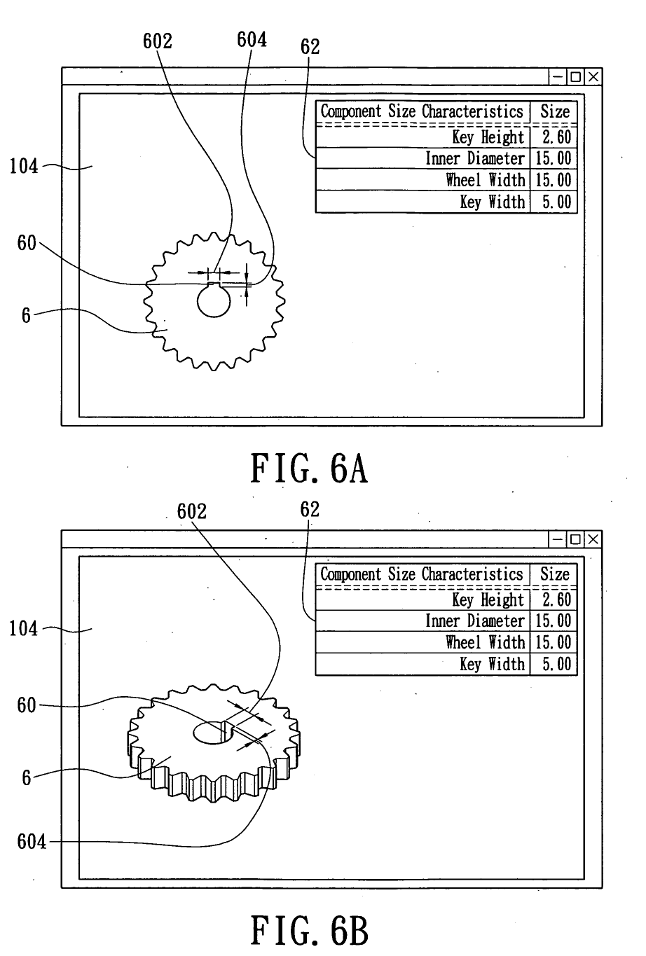

FIG. 2 shows a flowchart of an embodiment for the 3D model dynamic orientation setting method according to the present invention, which illustrates the setting steps for dynamic orientation on the feature of at least one component in the object model displayed on the user interface, comprising: first, from a model database 102, reading each component related with an object model as well as the identification data and size value for the size feature of each component recorded therein (S201); for example, the components like hub, inner diameter, key, gear teeth and so on for the aforementioned gear, and the size features like length, height or width of each component; using the name of each size feature as the identification data thereof for user's recognition, then displaying the read data as above on a user interface 104, shown as the component data sheet 62 in FIG. 6A (S203). Next, based on a selection command, selecting the identification data for one of the size features listed on the user interface 104 (S205), then in accordance with the selected size,feature, drawing the component which, based on the size value thereof, displays the size feature as well as the size feature and size value on the user interface 104 by a component setting module 106 (S207). Referring to FIG. 6A and taking the key 60 of the gear 6 for example, when selecting to preview the component, i.e. the key, based on the selection command, the component setting module 106 draws the perspective view of the gear 6 and relative position thereof to the key 60, and indicates the key length 602 or key height 604 over the portion at which the key 60 is located, so the user can immediately appreciate the relationship between the component and the object model from the picture shown on the user interface 104.

Subsequently, an operation command is received by the component setting module 106 for rotating the component presenting the size feature on the user interface 104 in order to adjust the viewing angle (S209); as shown in FIG. 6B, after rotation, it is possible to preview the height or width of the key 60 at different viewing angle. To memorize the aforementioned modified viewing angle after rotation of the component displaying the size feature for future reuse, it further receives an update command to read a viewing parameter of the component generated after rotation (S211).

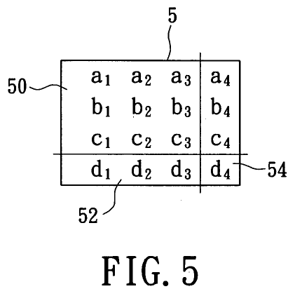

The viewing angle in the present embodiment is to control the viewing angle matrix values of the viewing angle, position and scale when the component displays the size feature on the user interface 104. Refer now to FIG. 5, a diagram of viewing angle matrix, wherein the 3D model is a coordinate system converted from a 4D viewing angle coordinate matrix 5 for controlling the display pattern thereof on the user interface 104, in which the values in the rotation control area 50 (i.e. a₁˜a₃, b₁˜b₃ and c₁˜c₃) affect the rotation of the 3D model; that is, it is used to control the rotation of the object model on the user interface 104. The transition control area 52 (i.e. d₁˜d₃) and the scale control area 54 (i.e. d₄) also respectively controls the transition and the scale of the object model. Therefore, the viewing parameter generated as above is acquired from the rotation operation performed on the component by the component setting module 106, which leads to changes on the rotation control area 50 within the viewing angle coordinate matrix 5. It is particularly noted that the rotation control area 50 can, in addition to the rotation of the 3D model, be also used to control the transformation of perspective of the model, whereas in the present embodiment it is specifically directed to the function of rotation operation for discussions.

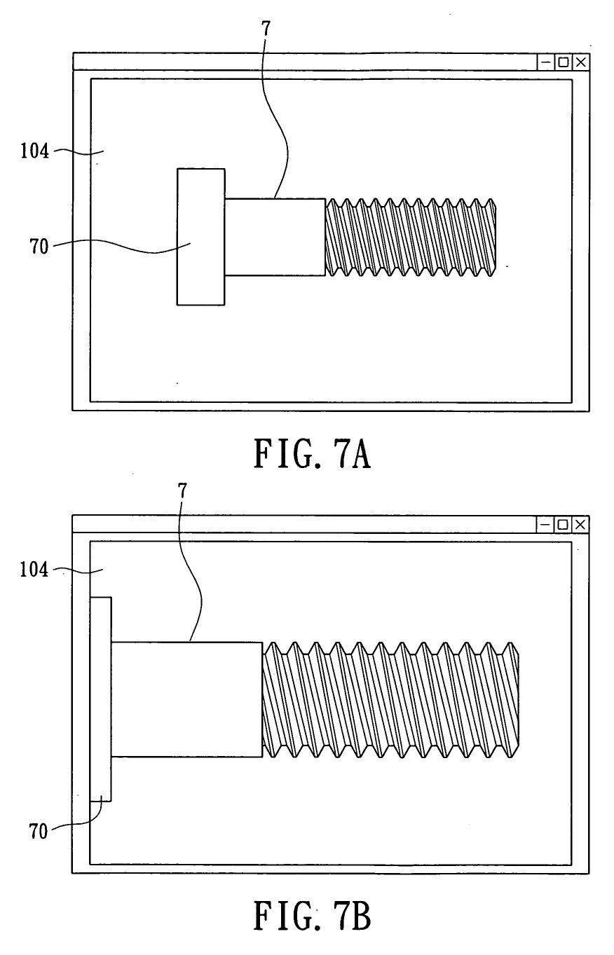

Next, since errors may occur in component display due to transition or scale operations of the component on the user interface 104 when adjusting the viewing angle of the component presenting the size feature, as a component, the head 70, of the bolt 7 shown in FIG. 7A, exceeds the display range of the user interface 104 in FIG. 7B. Therefore, after reading the viewing angle, it further determines whether the parameter of the transition control area 52 or the scale control area 54 in the viewing angle coordinate matrix 5 of the component is correct (S213); that is, to compare the parameters of the transition control area 52 and the scale control area 54 with a specific transition parameter and a specific scale parameter to see if they are equal. If it is found that the display of the transition position and scale value is incorrect, then the component setting module 106 modifies the value in the transition control area 52 based on the said specific transition parameter, such as a prescribed 3D coordinate value, and adjusts the scale control area 54 based on the specific scale parameter, such as a prescribed display zoom value, thus allowing to restore the display scale back to 1 (S215), thereby displaying the component presenting the size feature at a suitable position on the user interface 104 with appropriate scale.

Finally, it transfers the viewing parameter and the identification data of the size feature after adjustment of the component by the component access module 108 to the storage unit 110 for storage (S2 17), and redraws the component in accordance with the final adjusted viewing angle so as to display the component and the size feature thereof at suitable viewing angle, position and scale on the user interface 104.

In the present embodiment, before displaying the data coming from the model database 102 on the user interface 104 (S203), it may additionally filter each component and each size feature thereof according to the requirements on the 3D model, thereby selecting the major or frequently used components and size features thereof to be displayed on the user interface 104.

Through rotating the component displaying the size feature on the user interface 104 based on the operation command, and recording the viewing angle coordinate matrix 5 after rotation, the setting operation for orienting the viewing angle of the size feature of each component in the 3D model is thus completed.

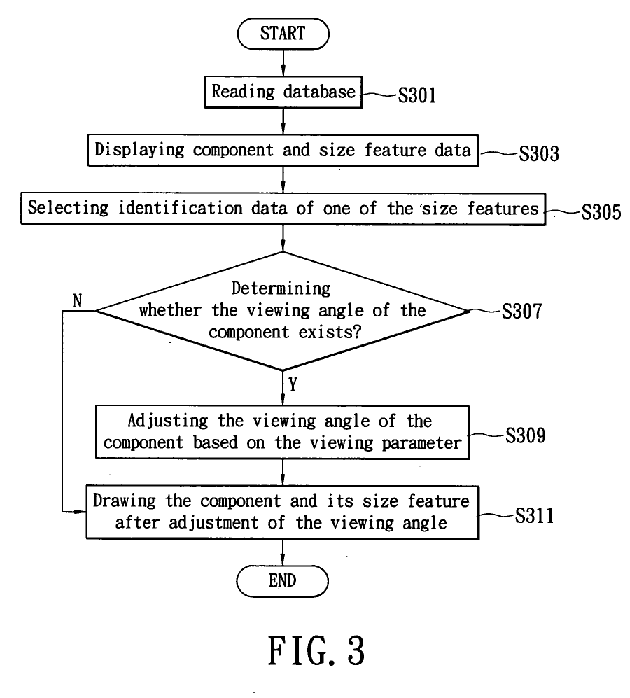

FIG. 3 is a flowchart of an embodiment for the 3D model dynamic orientation previewing method according to the present invention. As the embodiment flowchart shown in FIG. 2, the present embodiment also first reads from the model database 102 the object model and component as well as size feature data (S301), then displays them on the user interface 104 (S303) to enable selection of the identification data of the size feature for one of the components listed thereon.

After selecting the identification data of one size feature (S305), it first links to the storage unit 110 through the component access module 108 based on the identification data of selected size feature to search and determine whether the viewing parameter of the component displaying the size feature, i.e. the viewing angle coordinate matrix 5 in the aforementioned embodiment, are stored (S307). If it is determined that there is no such a viewing angle of the component in the storage unit 110, indicating the component displaying the size feature has never been set for viewing angle adjustment, then it prompts such a message on the user interface 104 and directly draws the component and the size feature thereof on the user interface 104 by the component setting module 106 based on the size value of the size feature (S311); but, in case that it is found that the viewing angle coordinate matrix 5 of the component indeed exists in the storage unit 110, then it reads the matrix and causes the component setting module 106 to adjust the viewing angle of the component based on the viewing angle coordinate matrix 5 (S309), subsequently draws the component and the size feature thereof on the user interface 104 (S311).

The above-mentioned descriptions have disclosed embodiments for the method of 3D model dynamic orientation, in which the size feature of each component in the object model can be rendered on the user interface 104 at a well-defined viewing angle, without having to be limited at the default fixed angle in the 3D model, thereby improving the conveniences in operations and previewing.

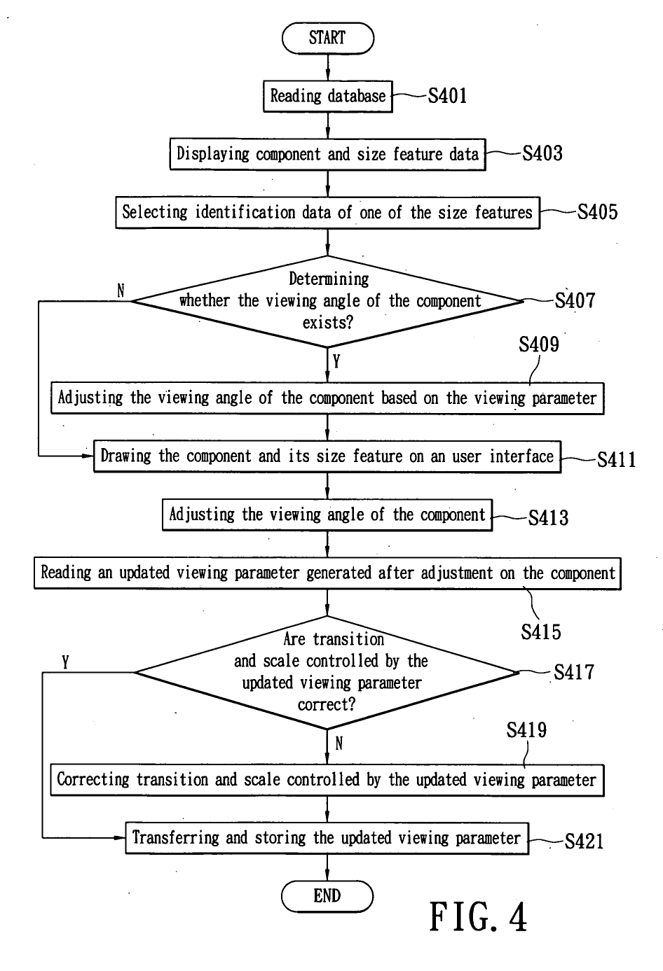

FIG. 4 shows a flowchart of an embodiment for the 3D model dynamic orientation executing method according to the present invention, in which the present embodiment is capable of implementing the functions of recording viewing angle and setting viewing angle for each component in the object model performed in the aforementioned embodiments, and also allowing to display the size feature on the user interface 104 in accordance with the display settings of each component based on the adjusted viewing angle of the stored viewing parameter for the component.

The implementing steps of the embodiment comprise: reading from the model database 102 the object model and components thereof as well as the identification data and size value of the size features (S401), then displaying on the user interface 104 (S403); through a selection command, selecting the identification data of one size feature (S405), as illustrated in FIG. 3, proceeding to the storage unit 110 to determine whether the viewing angle exists therein (S407); after finding the viewing angle, adjusting the viewing angle of the component displaying the size feature based on the contents of the viewing parameter (S409), then drawing the component as well as the size feature and size value thereof (S411); or otherwise, in case the viewing parameter does not exist in the storage unit 110, prompting such a status on the user interface 104 and directly drawing the component and the size feature thereof (S411).

Upon further reception of an operation command for adjusting the viewing angle of the component shown on the user interface 104, thus performing rotation operation on the component and thereby modifying the viewing angle thereof (S413), then, by way of e.g. pressing down an update button to generate an update command, reading an updated viewing angle parameter, i.e. a viewing angle coordinate matrix 5 having different values, generated due to re-adjusting the viewing angle of the component based on such an update command (S415). Meanwhile, further checking whether the transition position and scale of the component after rotating the viewing angle are correct (S417); if errors occur in the displayed picture due to transition or scale changes, as shown in FIG. 7B, then performing adjustment in comparison with the transition parameter (e.g. a prescribed 3D coordinate value) or scale (e.g. a prescribed scale value) (S419), allowing to correctly display the component and size feature thereof, in which the detailed descriptions on the adjustment and comparison processes can be referred to the illustrations as steps S207 to S215 shown in FIG. 2, herein accordingly omitted for brevity.

Finally, transferring the viewing angle coordinate matrix 5 updated, or even corrected, in terms of transition and scale to the storage unit 110 by the component access module 108 for storage, in replacement of the previously set viewing angle coordinate matrix 5 (S421). If the component has never been set for the viewing angle adjustment, then the read updated viewing parameter is considered as being equivalent to the viewing parameter generated for the first time with regards to a different viewing angle set for the component displaying the size feature, and can be directly transferred to the storage unit 110 as a new record.

In this way, when in next time selecting the identification data of the size feature again (S405), it is possible to read the updated viewing parameter of the component displaying the size feature and show the size feature of the component at another different viewing angle on the user interface 104.

Furthermore, the methods, or specific forms or portions thereof, according to the present invention can be included in physical media such as a floppy disc, a CD-ROM, a hard disc or any other machine readable (e.g. computer readable) storage media in a form of program codes. When the program codes are loaded and executed in the machine (e.g. a computer), such a machine becomes a device used to participate in the present invention. The methods according to the present invention can be transferred in a form of program codes through various transferring media (such as computer, cable line, optic fiber or any types of transmission). Herein, upon loading and executing the program codes in the machine (e.g. the computer), such a machine becomes a device used to participate in the present invention. As implemented on a general purpose processor, the program codes in conjunction with the processor can provide a unique device similar to an application specific logic circuit.

Upon loading and executing the methods according to the present invention in a form of program codes, it allows to improve defects found in 3D model drawing tools such as Pro/ENGINEER etc., thereby facilitating better flexibility and convenience as users preview each component and size feature thereof of various model.

In summary, it can be seen that the disclosure of the present invention has clearly described the approaches to dynamically adjust and set the viewing angle of the size feature for the component in a 3D model, providing very usable improvements on operations and usage of currently available 3D model drawing tools, thus significantly enhancing the convenience in user operations and increasing application effectiveness of the drawing tools.

The contents described hereinbefore is by no means intended to restrict the applicable scope of the present invention. All other technical means conforming to the spirit of the present invention and not essentially altering the present invention are deemed to be encompassed by the legally protected scope claimed by the present invention.

What is claimed is:

1. A setting method for dynamically orienting 3D models, applicable for setting a viewing angle of at least one component in an object model shown on a user interface, comprising the following steps:
receiving an operation command, and performing adjustment on viewing angle of a component used to present a size feature displayed on the user interface based on the operation command;
receiving an update command, and reading a viewing parameter generated for the component after the said adjustment on viewing angle; and
transferring the viewing angle to a storage unit for storage;
wherein the viewing parameter is used to control the viewing angle, position and scale when the component presents the size feature on the user interface.

2. The setting method for dynamically orienting 3D models according to claim 1, prior to the step of receiving the operation command to adjust the viewing angle, further comprising the following steps:
reading the components of the object model recorded in a model database as well as the identification data and size value of the size feature of each component;
displaying the identification data of the size feature of the components on the user interface;
selecting one of the identification data of the size feature based on a selection command; and
drawing, based on the size value of the selected size feature, the component displaying the size feature, and showing the component, the size feature and the size value on the user interface.

3. The setting method for dynamically orienting 3D models according to claim 1, further comprising:
transferring the identification data of the size feature of the component to the storage unit to identify the viewing parameter of the component displaying the size feature.

4. The setting method for dynamically orienting 3D models according to claim 1, wherein the viewing parameter is a viewing angle coordinate matrix, consisting of a rotation control area, a transition control area and a scale control area respectively used to control the rotation, transition and scale of the component when displaying the size feature on the user interface.

5. The setting method for dynamically orienting 3D models according to claim 4, wherein the viewing angle adjustment performed on the component displaying the size feature on the user interface consists of rotating the component, thereby modifying the rotation control area in the viewing angle coordinate matrix.

6. The setting method for dynamically orienting 3D models according to claim 4, after the step of receiving the update command to read the viewing angle, further comprising the following steps:
determining whether the parameter values controlling the transition and scale of the component in the viewing parameter are correct; and
adjusting the viewing parameter if the parameter values controlling the transition and scale of the component in the viewing parameter are incorrect.

7. The setting method for dynamically orienting 3D models according to claim 6, within the step of adjusting the viewing parameter, further comprising the following step:
adjusting the parameter values of the transition control area and the scale control area in the viewing parameter respectively based on a transition parameter and a scale parameter.

8. A previewing method for dynamically orienting 3D models, applicable for previewing the viewing angle of at least one component of an objective model, comprising the following steps:
selecting an identification data of a size feature of the component based on a selection command;
reading a storage unit and determining whether a viewing parameter of the component displaying the size feature is stored in the storage unit;
reading the viewing parameter if the viewing parameter exists in the storage unit;
performing adjustment on the viewing angle of the component based on the viewing parameter; and
drawing the component displaying the size feature based on the viewing angle of the component displaying the size feature, and drawing the size feature and the size value of the component, and showing them all on a user interface;
wherein the viewing parameter is used to control the viewing angle, position and scale when the component presents the size feature on the user interface.

9. The previewing method for dynamically orienting 3D models according to claim 8, further comprising the following steps prior to the step of selecting the identification data of the size feature of the component based on the selection command:
reading the components of the object model recorded in a model database as well as the identification data and size value of the size feature of each component; and
displaying the identification data of the size feature of the components on the user interface.

10. The previewing method for dynamically orienting 3D models according to claim 8, further comprising the following step after the step of determining whether the viewing parameter has been stored:
prompting that the viewing angle is not stored on the user interface if the storage unit has not stored the viewing parameter.

11. The previewing method for dynamically orienting 3D models according to claim 8, wherein the viewing parameter is a viewing angle coordinate matrix, consisting of a rotation control area, a transition control area and a scale control area respectively used to control the rotation, transition and scale of the component when displaying the size feature on the user interface.

12. A machine readable medium, which stores a computer program that, when executed, enables a processor to perform the previewing method for dynamically orienting 3D models according to claim 8.
